(19) United States
(12) Patent Application Publication
(10) Pub. No.: US 2009/0012972 A1
(43) Pub. Date: Jan. 8, 2009

(54) System for Processing Unstructured Data

(76) Inventor: Hendrik Leitner, Muenchen (DE)

Correspondence Address: SLATER & MATSIL, L.L.P., 17950 PRESTON RD, SUITE 1000, DALLAS, TX, 75252-5793, US

(21) Appl. No.: 12/044,695

(22) Filed: Mar. 7, 2008

(30) Foreign Application Priority Data
Mar. 8, 2007 (DE) 10 2007 011 407.0

(51) Int. Cl. G06F 17/30

(52) U.S. Cl. 707/100; 707/E17.033

(57) ABSTRACT

A device can be used for the processing of unstructured data and for the storage of related metadata. The data is classified and a rule is applied by means of which at least one parameter is defined in a data-specific manner and based on the classification result. The parameter includes retention period of the data and/or security settings for the data. The data and information related to the at least one parameter can then be stored.

This application claims priority to German Patent Application 10 2007 011 407.0, which was filed Mar. 8, 2007 and is incorporated herein by reference.

### TECHNICAL FIELD

Embodiments of the invention relate to a device for the processing of unstructured data and for the storage of related metadata in a storage unit having an interface for reading in the unstructured data, an encryption unit for the encryption of data, if necessary, and a classification unit for the classification of the unstructured data based on the content of the data. An embodiment of the invention also relates to a method for processing unstructured data.

### BACKGROUND

In a company, data are available as structured data or unstructured data. Structured data are data stored, for example, in a database enabling the systematic access of these data. A concrete example of structured data is data stored in an SAP system. Unstructured data, on the other hand, are, for example, text or e-mails stored in an electronic storage system, which, however, does not allow their systematic access.

Unstructured data are problematic in various respects. On the one hand, frequently, data cannot be accessed because it is not known under which file name and at which location in a directory structure the data are stored. On the other hand, security problems can arise because confidential data are stored in a way that allows unauthorized individuals to access them as well. In addition, multiple storage of data constitutes a problem. This leads to a large amount of storage space being unnecessarily taken up. Data may also be stored for longer periods of time than necessary. This also leads to much storage capacity having to be provided for data which, for all intents and purposes, is no longer needed.

In order to be able to access unstructured data, it is known that it is possible to locate data using a search routine if the data are made available as full text. A database can be built using the full text data, making it possible to quickly access the data classified accordingly. Taking into consideration security problems, it is also known that data encryption can be utilized so that confidential data cannot be read, even if stored at a location accessible to unauthorized individuals. However, the fact that it is difficult to control the rapidly growing data volume, due to the large amount of continuously generated new data, continues to be a problem.

### SUMMARY OF THE INVENTION

Embodiments of the invention are related to the technical problem of providing a device for the processing of unstructured data which improves the storage efficiency.

This problem can be solved by a device of the type mentioned in the introduction, which is characterized in that a programmable control unit is provided that makes it possible to define at least one of the following parameters in a manner specific to the data, based on a rule and at least one classification result: retention time of the data or security settings for the data.

In addition, the problem can be solved by a method for processing unstructured data and for storing related metadata in a storage unit, using the following steps: classification of the data and application of a rule, by means of which at least one of the following parameters is defined in a manner specific to the data and based on the classification result: retention time of the data or security settings for the data.

The rule-based definition of the above parameters makes an ongoing automatic optimization of the data inventory possible. The programmable control unit makes it possible to establish, based on a company policy, legal provisions or other guidelines, which values are defined for the above-named parameters.

Based on the rule-based parameter definition, it is possible to perform an automatic optimization of the data inventory. For example, data for which multiple copies exist may be deleted; data no longer needed may be deleted; data may be moved to a slow archival storage means, such as, for example, tapes. In this context, aspects concerning security may also be taken into consideration. For example, different storage parameters with respect to duration, security or redundancy may be specified for confidential documents as compared to non-critical documents.

It is also possible to use a key to identify data that has to be retained for an especially long time or data that may be deleted especially quickly. Apart from that, it is possible to initiate automatic encryption of data in the event that it is detected that the data are confidential. If it is detected during the classification that the data are, for example, confidential company data, a simple key is used. If, however, it is data that should not leave a specific group of executives, a different key is to be used.

In an advantageous further development of the invention, the control unit can assume a double function in that, based on the stored data-specific parameters, a processing of the data is carried out, in particular archiving or deletion of data that are no longer needed.

### BRIEF DESCRIPTION OF THE DRAWINGS

The invention will be explained in more detail in the following, using an embodiment. The figures show:

FIG. 1 is a first embodiment of a device in accordance with the invention;

FIG. 2 is a second embodiment of a device in accordance with the invention;

FIG. 3 is a detailed structure of a device in accordance with the invention; and

FIG. 4 is a detailed structure of a system in accordance with the invention, having different storage units.

The following reference numbers can be used in conjunction with the drawings:
1 Storage unit
2 Interface
3 Encryption unit
4 Classification unit
5 Control unit
6 Key administration unit
7 Key destruction unit
8 Security unit
9 Catalogue unit
10 Index unit
11 Search unit
12 Report unit
13 Action interface
14 Fast hard disk storage
15 Archival storage

### DETAILED DESCRIPTION OF ILLUSTRATIVE EMBODIMENTS

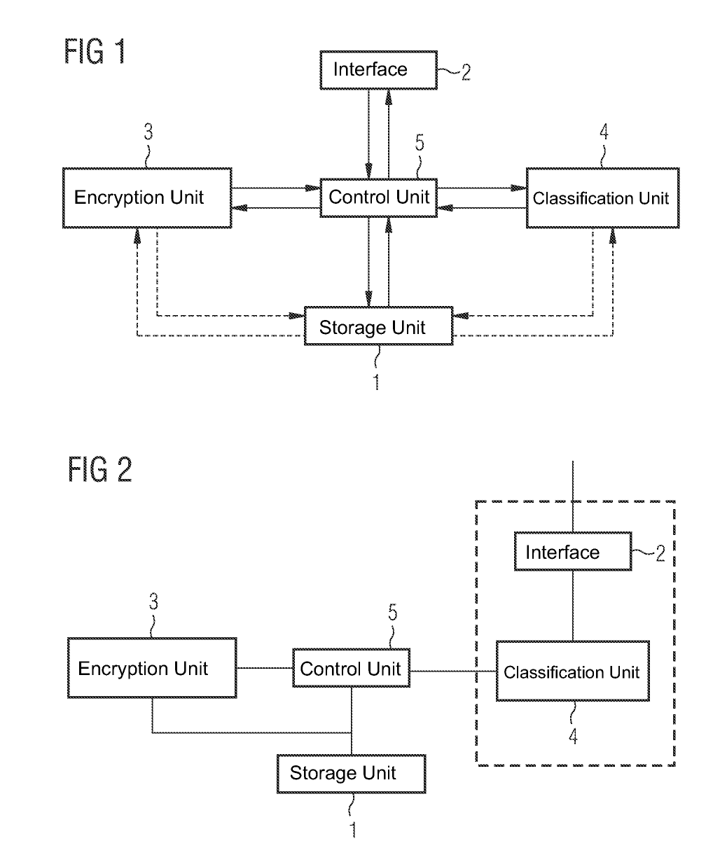

FIG. 1 shows a first embodiment of a device for the processing of unstructured data in accordance with the invention. Unstructured data are read in via an interface unit 2. They arrive at a control unit 5, which determines the further processing of the data. In the embodiment described, the data are routed from control unit 5 to a classification unit 4 in order to be analyzed for content. During the classification, it is detected, for example,
whether the data are confidential,
whether the data are legally relevant and may have to be retained for a long time,
whether the data are relevant for accounting purposes,
and so on.

Classification unit 4 can be realized, for example, using a product of the company Kazeon Systems, Inc., for example, software such as Information Server IS 1200-ECS. The classification result is then returned to the control unit 5 either by itself or in conjunction with the classified data.

Control unit 5 now determines, based on a rule, how to proceed further with the data. In a first alternative, the data are deposited in storage unit 1. The classification result is also deposited in storage unit 1 or a different storage unit. The classification result constitutes metadata that can be stored, for example, in a database. In conjunction with the classification result, full text information on the unstructured data is also deposited in the database.

In a second alternative, the processed data remain stored at their original storage location, and only the metadata, i.e., the classification result and/or full text information, are deposited in storage unit 1. It is also possible to create an index that is deposited in storage unit 1.

Based on a rule, data-specific parameters are determined from the classification result, with the parameters also being deposited in storage unit 1. The data-specific parameters are at least the retention time of the data or the security settings for the data. The retention time of the data depends on a multitude of conditions. For example, certain data have to be retained for 30 years in Germany because it is possible that claims can be asserted against the owner of data that are subject to a 30 year statute of limitations. In the event that such claims are asserted, the relevant document must still be available.

In the event, however, that the system in accordance with an embodiment of the invention is used in a different country, the statutes of limitation may be different. But it is also possible for a case to arise where the data are not relevant for Germany but only, for example, for France. In this embodiment, the rule provides for different retention periods for different countries. Accordingly, if the classification unit recognizes that the data are relevant for Germany, the retention period is set to 30 years. It may be established, at the same time, that, although the data are to be retained for 30 years, there is a low probability that they will be accessed. This parameter is also stored and may be used, at a later time, to move data from a relatively fast storage unit to a slower, cheaper storage unit.

Based on the classification result, it is also possible to determine whether the data are subject to increased security requirements. If, for example, the specification “company confidential” is detected on a document, this document is either protected by the respective access authorizations or encrypted with a key. How the data are dealt with is a matter of company policy and determined accordingly by a rule. Thus, if a rule establishes that documents labeled as company confidential are to be encrypted, the respective rule causes a document classified as company confidential to be routed to an encryption unit 3 in order to be encrypted. The information as to the level of security to be used as a basis for the encryption is also passed on.

Encryption unit 3 encrypts the data and either deposits it directly in storage unit 1 or sends it back to control unit 5 in order to be passed on to storage unit 1. The storage of data by means of bypassing control unit 5 may be advantageous because it unburdens control unit 5. It may also be advantageous not only to return the classification result to control unit 5 from classification unit 4, but to affect the storage in storage unit 1 directly.

It is also possible to use the system presented in FIG. 1 in the “reverse” direction. In one embodiment, control unit 5 is set up to delete data regularly as soon as the retention period has expired. For this purpose, control unit 5 obtains, from storage unit 1, the data-specific parameters related to the retention period of data. When data are stored in storage unit 1, they can be deleted there directly. If, however, only the metadata are stored in storage unit 1 and the actual data are deposited on a different storage medium, control unit 5 will access the data via interface 2 and delete it.

In one embodiment, the various units shown in FIG. 1 are software components which run on common hardware. In that case, encryption unit 3, control unit 5 and classification unit 4 are application programs that are run on a shared server.

But in a powerful version of the device in accordance with an embodiment of the invention, it is advantageous to use several component computers to form the various units. Such an embodiment of the invention is shown in FIG. 2. In accordance with this arrangement, several so-called component computers are used, each of which has a least a central processing unit and working memory. They are, therefore, computers capable of running an application independent of the other component computers. They can thus be separate servers.

An advantage of this arrangement is that the processing of a large volume of data is possible without classification unit 4, control unit 5 and encryption unit 3 interfering with each other. Here it is especially advantageous that the data are first fed directly to classification unit 4, where they are examined. The classification of the data is required in any case so that this action can be carried out without burdening control unit 5. For this purpose, interface 2, via which the data are read in, is directly connected to classification unit 4.

The classified data or the classification result is passed on to control unit 5, which is run on a different component computer. Encryption unit 3 is also established on a separate component computer. The encryption of data is a relatively computation-intensive activity that can thus be carried out without the classification of data, which is also a computation-intensive activity, being obstructed. Encryption unit 3 is directly connected to storage unit 1 so that it is possible to deposit data in storage unit 1 without burdening control unit 5. The data-specific parameters determined by control unit 5 based on a rule may be deposited directly in storage unit 1. In the event that the encrypted data are not to be deposited in storage unit 1, but outside of the system shown here, a connection between encryption unit 3 and interface 2 is provided in order to store data, for example, at the location from which the unstructured data were read in.

The activity of control unit 5 is the least computation-intensive so that it is not imperative to provide a separate component computer. The control unit 5 can therefore be set up either on the component computer on which encryption unit 3 is set up as well or on the component computer on which classification unit 4 is set up.

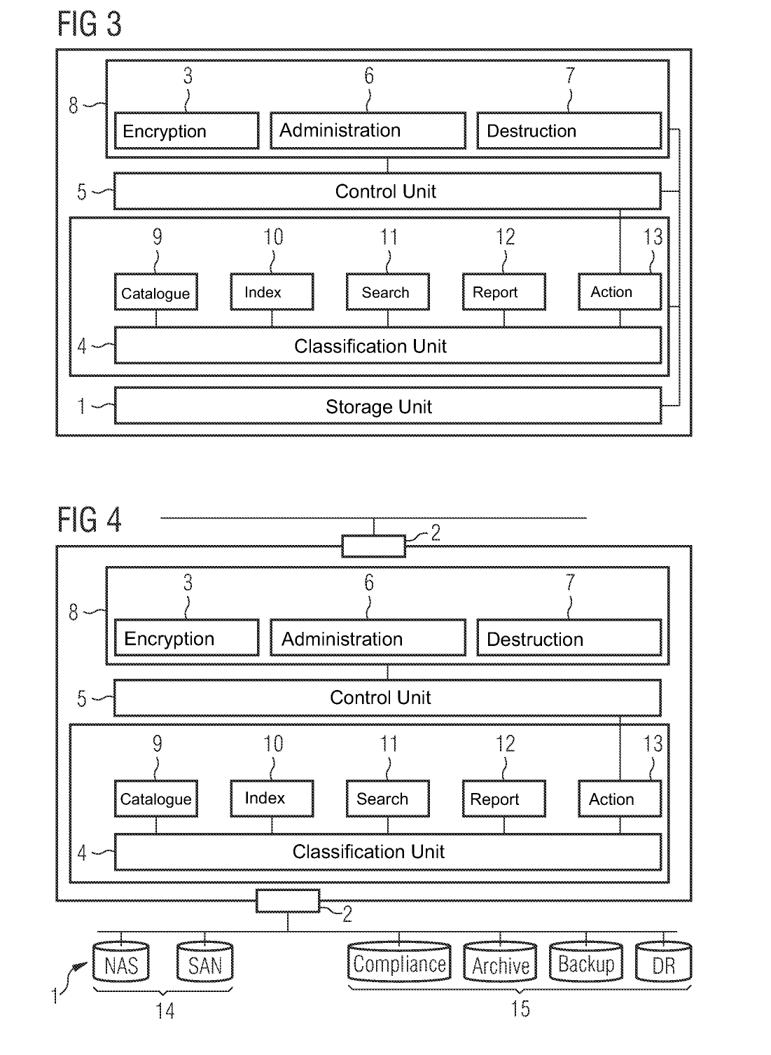

FIG. 3 shows a detailed structure of the system shown in FIGS. 1 and 2. Encryption unit 3 may be part of a more complex security unit 8, which also handles, in addition to pure encryption, key administration in a key administration unit 6 as well as the destruction in a key destruction unit 7. Such a security unit is known from the product Data Fort of the company Decru (owned by Network Appliance Inc.).

Classification unit 4 comprises components 9 and 10 for the creation of a catalogue or an index, a search unit 11 and a report unit 12. The actions to be performed can be controlled via an action interface 13.

A Primergy server of the company Fujitsu Siemens Computers GmbH is used to execute the various units of the system. Preferably, this server is a Blade Server, with the various units being executed on various Blades as described based on FIG. 2.

The rule of control unit 5 can also be established so that parameters are set or decisions made as to whether data deposited in storage unit 1 are made independent of the location of the data source. If, for example, a file read in via interface 2 originates from a notebook of an employee, it makes sense to deposit this data, and not only the metadata, in storage unit 1, because notebooks involve the relatively high risk of data being lost because they are deleted by the user or because the notebook is lost or becomes inoperable. Concerning operationally critical data, it is sensible to set up a rule that deposits the data in storage unit 1 when such a configuration is detected. If, however, the data to be classified originate, for example, from a branch office that practices its own data securing processes, the data may remain stored there and need not be deposited in storage unit 1. For centralized access, it is sufficient to store the metadata. If the data are classified as not forming part of the company's core business activities, for example music files, no information is stored or, if this is in line with the company policy, the information is deleted immediately.

Unit 12 shown for the creation of reports serves to retrieve information on the data inventory. For example, a report may be designed to determine the amount of confidential data or to find data relevant for a financial audit or an environmental audit.

Control unit 5 presents a rule which, at regular intervals, scans the entire storage system to which it has access for modified or newly added data which are then read in and processed in the manner according to the invention. In this way, it is possible to ensure that the entire data set is captured.

In company-internal applications, there are three aspects of the impact made by the use of the system in accordance with the invention. Costs for the storage of unstructured data are reduced; company risks are reduced; and the value of data is made accessible.

With respect to the “cost” aspect, it is noted that the storage of 1 GB of data currently costs about US $7. Since many companies need data storage with many thousands of GB capacity, the reduction of storage requirements by the efficient deletion of data is an effective measure to reduce costs.

With respect to the “risk” aspect, it is to be taken into account that, at times, access to data must be fast, for example, in court disputes. Apart from that, the data have to be complete in the sense that, depending on the legal requirements of the respective country, specific data are made available. The use of the system in accordance with embodiments makes it possible to identify and access the relevant data within a short amount of time. It is ensured that the data are still available in every case, for example, a case subject to legal provisions.

With respect to the “value of data,” it is noted that the system in accordance with embodiments of the invention enables the systematic access of all data of a company so that the value of the data may be taken advantage of and duplicate work involved in the creation of documents with similar content avoided.

FIG. 4 shows the connection with various storage systems that jointly constitute the above-mentioned storage unit 1. A fast hard disk system 14 is provided for the initial storage of data, and it constitutes a part of storage unit 1. If data are accessed frequently, the data will remain on this hard disk system for an extended period of time. Data that are not needed at short notice are deposited on slower storage media 15, such as a WORM system or tapes. Based on the parameters set in a rule-based manner, it is possible to detect which data will most likely not be used very often or accessed quickly. Thus the available storage capacity may be utilized efficiently.

What is claimed is:

1. A device for processing unstructured data and for storing related metadata, the device comprising:
an interface to read in unstructured data;
a classification unit to classify the unstructured data based on content of the data; an encryption unit operable to encrypt the unstructured data;
a programmable control unit by means of which at least one parameter can be defined in a data-specific manner and based on a rule and at least one classification result, the at least one parameter comprising retention period of the data and/or security settings of the data; and
a storage unit to store data based on the unstructured data.

2. The device in accordance with claim 1, wherein the at least one parameter comprises security settings, the security settings including access authorization.

3. The device in accordance with claim 1, wherein the at least one parameter comprises security settings, the security settings including information on encryption.

4. The device in accordance with claim 3, wherein the security settings include information on a type of key to be used.

5. The device in accordance with claim 1, wherein the rule defines the at least one parameter depending on a country specification.

6. The device in accordance with claim 1, wherein the rule defines the at least one parameter depending on a level of confidentiality detected during the classification.

7. The device in accordance with claim 1, wherein the rule defines the at least one parameter depending on an owner of the data detected during the classification.

8. The device in accordance with claim 1, wherein the control unit is set up to perform the processing of the data based on stored data-specific parameters.

9. The device in accordance with claim 8, wherein the processing comprises archiving, deletion or systematic access.

10. The device in accordance with claim 1, wherein the classification unit is set up on at least one separate component computer having a central processing unit and a working memory.

11. The device in accordance with claim 1, wherein the interface is connected to the classification unit so that data read in arrives at the classification unit without going through the control unit.

12. The device in accordance with claim 1, wherein the encryption unit is set up on at least one separate component computer having a central processing unit and working memory.

13. The device in accordance with claim 1, wherein the control unit is set up on at least one separate component computer having a central processing unit and working memory.

14. The device in accordance with claim 1, wherein data determined to be encrypted by the control unit are routed to the encryption unit and that the encrypted data are stored in the storage unit without going through the control unit.

15. The device in accordance with claim 1, wherein:
the classification unit is set up on at least a first component computer having a central processing unit and a working memory; and
the encryption unit is set up on at least a second component computer having a central processing unit and a working memory, the second component computer being separate from the first component computer.

16. The device in accordance with claim 15, wherein the control unit is set up on at least a third component computer having a central processing unit and a working memory, the third component computer being separate from the first and second component computers.

17. The device in accordance with claim 1, wherein the interface, the classification unit, the encryption unit, and the control unit each comprises a software application that can run on a computer.

18. A device for processing unstructured data and for storing related metadata, the device comprising:
means for reading in unstructured data;
means for classifying the unstructured data based on content of the data;
means for encrypting the unstructured data;
means for defining at least one parameter, the at least one parameter being defined in a data-specific manner and based on a rule and at least one classification result, the at least one parameter comprising a retention period of the data and/or security settings of the data; and
means for storing data based on the unstructured data.

19. A method for processing unstructured data and for storing related metadata in a storage unit, the method comprising:
classifying the data;
applying a rule by means of which at least one parameter is defined in a data-specific manner and based on the classification result, the at least one parameter comprising a retention period of the data or security settings for the data; and
storing the data and information related to the at least one parameter.
